(19) United States
(12) Patent Application Publication
(10) Pub. No.: US 2014/0104171 A1
(43) Pub. Date: Apr. 17, 2014

(54) Electrical device, in particular a telecommunication device, having a projection device, and method for operating an electrical device

(71) Applicants: Christoph DELFS, Bretten (DE); Rajkumar JOSEPH, Pondicherry (IN); Saravanan JAYAPRAKASH, Karnataka (IL)

(72) Inventors: Christoph DELFS, Bretten (DE); Rajkumar JOSEPH, Pondicherry (IN); Saravanan JAYAPRAKASH, Karnataka (IL)

(73) Assignee: Robert Bosch GmbH, Stuttgart (DE)

(21) Appl. No.: 14/055,414

(22) Filed: Oct. 16, 2013

(30) Foreign Application Priority Data
Oct. 16, 2012 (DE) 10 2012 218 813.4

(51) Int. Cl. G06F 3/01

(52) U.S. Cl. CPC G06F 3/017
USPC 345/158; 345/156

(57) ABSTRACT

An electrical device having a projection device for projecting image information onto a projection surface disposed externally to the telecommunication device; an inertial sensor to detect a movement of the electrical device; the electrical device being operable in a first operating mode so that the projection of the image information onto the projection surface follows a movement of the electrical device with a movement component in a plane disposed in parallel to the plane of the projection surface; the electrical device being operable in a second operating mode so that, in spite of the electrical device's movement, the projection of the image information onto the projection surface with a movement component in a plane parallel to the plane of the projection surface is at least partially substantially fixed; the electrical device being configured so that its movement in the second operating mode is interpreted as a user input.

### RELATED APPLICATION INFORMATION

The present application claims priority to and the benefit of German patent application no. 10 2012 218 813.4, which was filed in Germany on Oct. 16, 2012, the disclosure of which is incorporated herein by reference.

### FIELD OF THE INVENTION

The present invention relates to an electrical device, in particular a telecommunication device, having a projection device for projecting image information onto a projection surface disposed externally to the electrical device, the electrical device having an inertial sensor, a movement of the electrical device being detectable by the inertial sensor.

### BACKGROUND INFORMATION

Such electrical devices, in particular telecommunication devices, are generally known. These are particularly in the form of telecommunication terminals, such as portable computers or portable telephone sets or the like that come equipped with a projection device.

An inherent advantage of such communication devices is that it is not just a comparatively small display area, respectively a display device of the electrical device that is provided for displaying image information. Rather—particularly when a plurality of people need to jointly view displayed image information, for instance during a conference or the like—the functionality is made possible whereby the image information is projected onto a projection surface disposed externally to the telecommunication device. When an image, respectively a film is displayed in this manner using a projection device—also referred to in the following as a beamer (projector), the control is generally provided in the case of stationary devices by a remote control and a corresponding menu control, the menu typically being directly displayed in the projected image. However, when a projection device is integrated in a typically portable electrical device, such as a telecommunication device, the functionality is often required whereby it is necessary for control elements, respectively control information to be transmitted, respectively communicated over the device, respectively for the device to receive a user input.

This is usually accomplished using a projection device that is implemented in a portable electrical device in that the electrical device, in particular a touch screen of the device, respectively an input device, such as a keyboard device or the like, must be touched, in particular by a finger of a user. For the most part, however, it is disadvantageous that little space is provided for input elements, such as control keys or operator controls, particularly on a portable electrical device. Also, with respect to the use of the projection device, the electrical device is often not optimally positioned for operation of the input elements by a user.

### SUMMARY OF THE INVENTION

The electrical device according to the present invention and the method according to the present invention for operating an electrical device in accordance with the coordinated independent claims have the advantage over the related art in that, besides a purely projection operation mode (described in the following as first operation mode), a second operating mode may be set which allows a user input to be realized very intuitively in that the electrical device is moved, namely by a movement of the electrical device in such a way that the movement has a movement component in a plane disposed in parallel to the plane of the projection surface. This makes it advantageously possible, for example, for an area of the image information displayed on the projection surface to be marked as a selection area, thereby allowing a control command to be sent to the electrical device in response to a user input generated in such a way. For example, such a user input may initiate a change in the volume of a playback or the switchover of static image information to another image, etc.

Advantageous embodiments and refinements of the present invention may be derived from the dependent claims, as well as from the description, with reference being made to the drawing.

One specific embodiment provides that the electrical device be configured in a way that allows the projection of the image information onto the projection surface to be increased or reduced in size in the second operating mode relative to the first operating mode.

This makes it advantageously possible in accordance with the present invention, on the one hand, to clearly indicate the setting of the second operating mode relative to the first operating mode, and, on the other hand, to facilitate the user input, respectively the implementation of a pointing movement in the image content of the displayed, respectively projected image information. The advantage of enlarging the display on the projection surface is that it allows a more accurate implementation of a pointing movement (relative to the image content). The advantage of a reduction in scale is that a larger image detail (respectively, even the entire image content) is projected in spite of a pointing movement.

In particular, in accordance with the present invention, the electrical device may be configured in such a way that, in the second operating mode, in response to the movement of the electrical device having a movement component in a plane disposed in parallel to the plane of the projection surface, a portion of the image information disappears on the projection surface, and a portion of the image information appears on the projection surface.

This makes it advantageously possible in accordance with the present invention, even in the case of a limited resolution of the projection device of the electrical device to provide an accurate display, respectively a comparatively large display of the image detail used for the pointing process.

The present invention may also provide that the electrical device be configured in such a way that, in the second operating mode, the projection of the image information onto the projection surface be at least partially substantially fixed in spite of the movement of the electrical device; however, that pointer projection information follow the movement of the electrical device with a movement component in a plane disposed in parallel to the plane of the projection surface.

This makes it advantageously possible in accordance with the present invention for the pointing operation, respectively the inputting by the user in the second operating mode of the electrical device to be implemented simply and conveniently because a user receives feedback about the movement of the electrical device from the display of the pointer projection information, for example, in accordance with a mouse pointer, respectively a cursor on a computer screen in response to a movement of the computer mouse. In this respect, displaying the pointer projection information, which results from the movement of the electrical device, although the remaining image content of the projected image remains fixed, respectively is projected as fixed image content, makes the user input readily executable.

The present invention may provide that the end of the user input by the user be signaled by a user input—for example, by the depressing of an actuation element of the electrical device, for instance a key and/or an area of a touch-sensitive display device.

In accordance with one specific embodiment, the present invention also provides that the encircled, selected screen area, i.e., that area of the projected image information encircled by the movement of the pointer projection information be displayed as a highlighted area relative to the remaining screen area (respectively, the remaining projected image information), for example, by a different coloration or the like. It especially may be that this highlighting of the selected screen area (particularly to enhance the display of the pointer projection information) occur already during the selection process and before the user input signaling the end of the user input by actuation of the actuation element.

In particular, the present invention provides that movements (in particular, unwanted movements, such as shaking or the like) be compensated during detection of the selection movement, i.e., in the second operating mode.

In addition, it may be provided in accordance with the present invention that the electrical device be a telecommunication device, in particular, a stationary or a portable telecommunication terminal, in particular, in the form of a portable computer or a portable cell phone.

This makes it advantageously possible in accordance with the present invention to use the projection device of such a device when a larger display area is desired, in particular, when the intention is that a plurality of people be able to see the image information at the same time.

Another object of the present invention is a method for operating an electrical device, in particular a telecommunication device, having a projection device in accordance with the coordinated independent device claim.

Exemplary embodiments of the present invention are illustrated in the drawing and explained in detail in the following description.

### BRIEF DESCRIPTION OF THE FIGURES

FIG. 1 shows a schematic perspective representation of an electrical device according to the present invention having a projection device.

FIG. 2 shows a schematic lateral view of an electrical device according to the present invention.

FIG. 3 shows a schematic representation of projection contents.

FIG. 4 shows another schematic representation of projection contents.

FIG. 5 shows another schematic representation of projection contents.

FIG. 6 shows another schematic representation of projection contents.

FIG. 7 shows another schematic representation of projection contents.

FIG. 8 shows another schematic representation of projection contents.

FIG. 9 shows another schematic representation of projection contents.

FIG. 10 shows another schematic representation of projection contents.

FIG. 11 shows another schematic representation of projection contents.

### DETAILED DESCRIPTION

Like parts are always denoted by the same reference numerals in the various figures, and are, therefore, also typically only named or mentioned once.

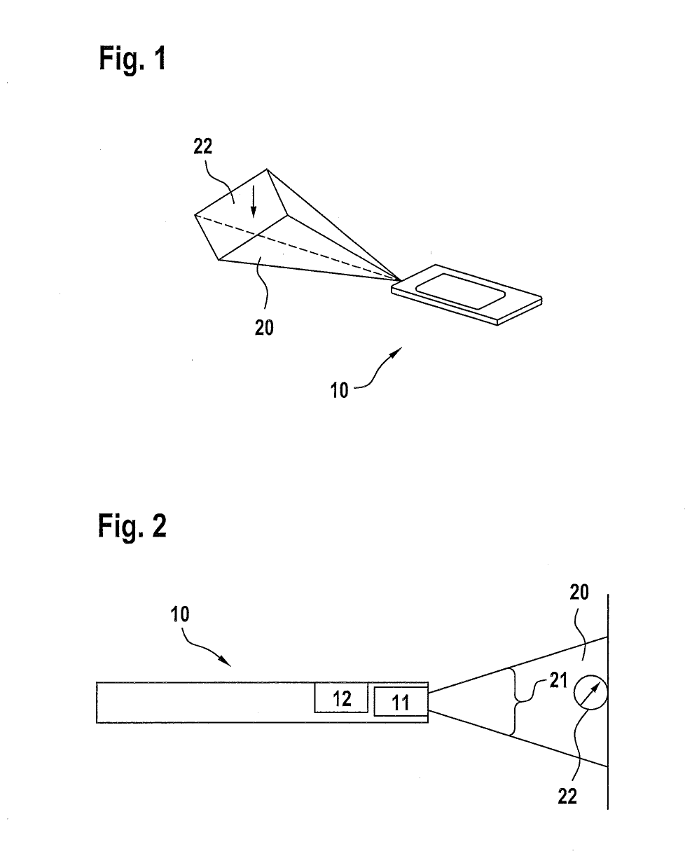

FIG. 1 shows a schematic perspective representation of an electrical device 10 that is capable of projecting image information onto a projection surface disposed externally to the electrical device. Starting from the electrical device, the image information is projected in various first directions of a projection direction area 20. A user input generated by a movement of the electrical device is detected by an inertial sensor 12. In this case, a user typically places electrical device 10 in his/her hand, thereby allowing the movement to be produced. The movement may be a movement of the electrical device having a movement component in a plane disposed in parallel to the plane of the projection surface. This means, for example, that the electrical device 10 is moved in a plane disposed in parallel to the projection plane, i.e., laterally to the projection plane, respectively has at least such a lateral movement component. Alternatively or additionally, a movement of the electrical device having a movement component in a plane disposed in parallel to the plane of the projection surface also means that a rotational movement of electrical device 10 is generated about an axis of rotation that resides in the plane disposed in parallel to the plane of the projection surface. To realize feedback about the user input, in particular, to realize location information, it may be provided in accordance with the present invention that pointer projection information 22 be displayed as part of the projected image information in projection direction area 20.

FIG. 2 schematically shows a lateral view of an electrical device 10 according to the present invention.

In accordance with the present invention, it is advantageously possible for inertial sensor 12 located in electrical device 10 to be utilized as a replacement for a pointing device (in particular, as a mouse replacement). Electrical device 10 is typically disposed on the rear or front side thereof during use of projection device 11.

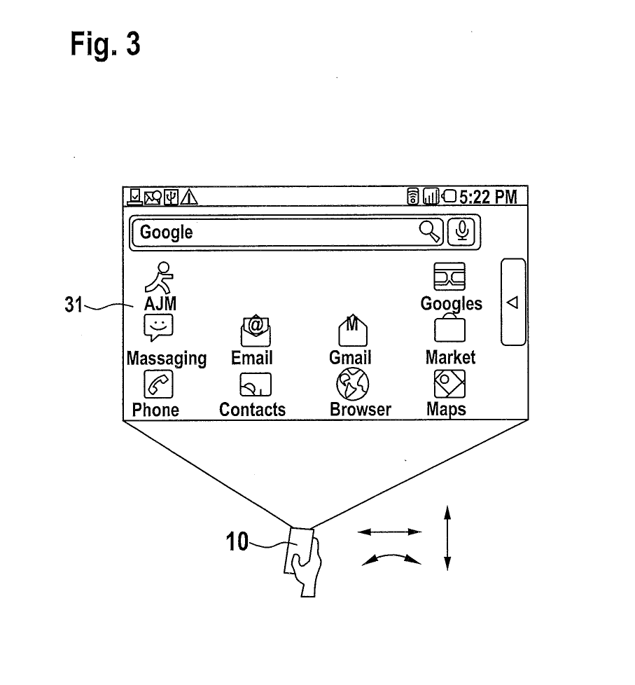

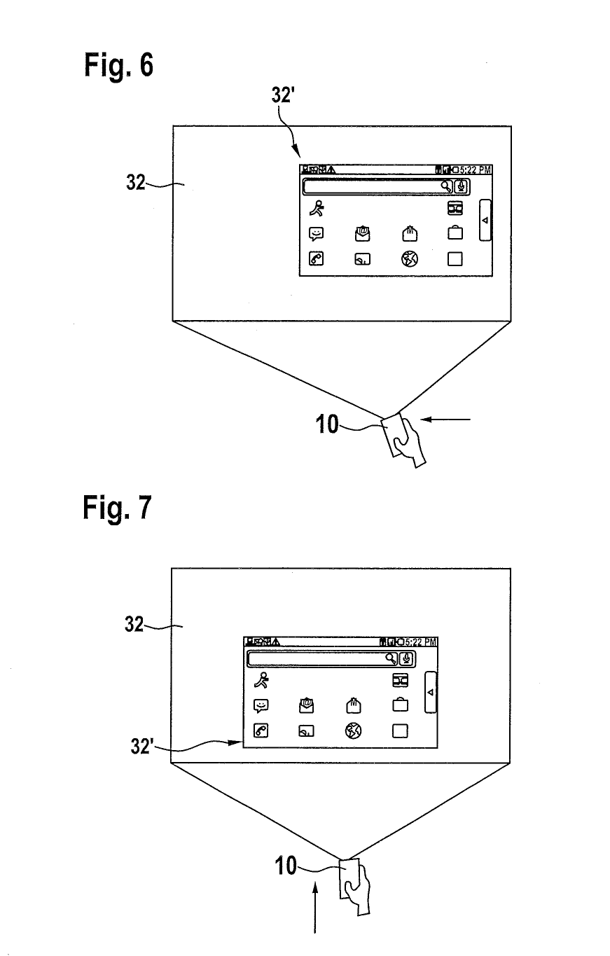

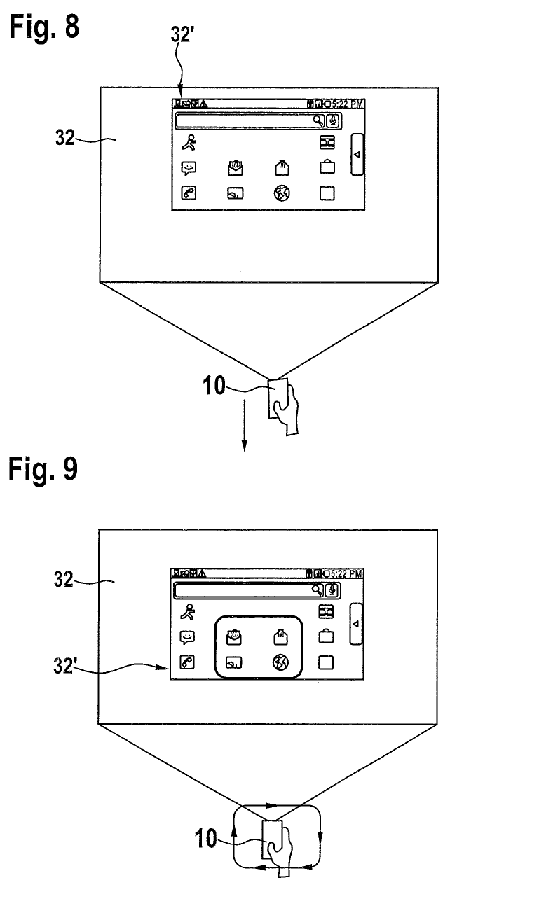

FIG. 3 through 11 show various schematic representations of projection contents to exemplarily illustrate the inventive functioning of electrical device 10. FIG. 3 shows exemplarily a first image content 31, which includes the complete projection area of electrical device 10. FIG. 3 represents an example of the first operating mode of the electrical device, where a movement of electrical device 10 having a movement component in a plane disposed in parallel to the plane of the projection surface leads to a displacement of the complete projected image; i.e., if a user (see the hand shown schematically in FIG. 3) were to move electrical device 10 in parallel to the projection plane along the arrows shown on the right side, the projected image would be identical in each case to the image content, but displaced from the projection location (within the projection surface).

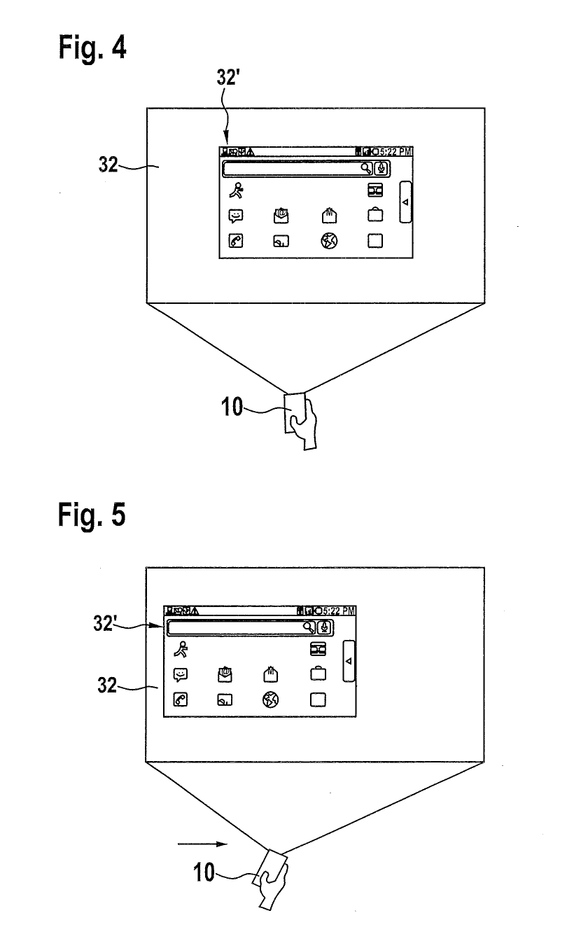

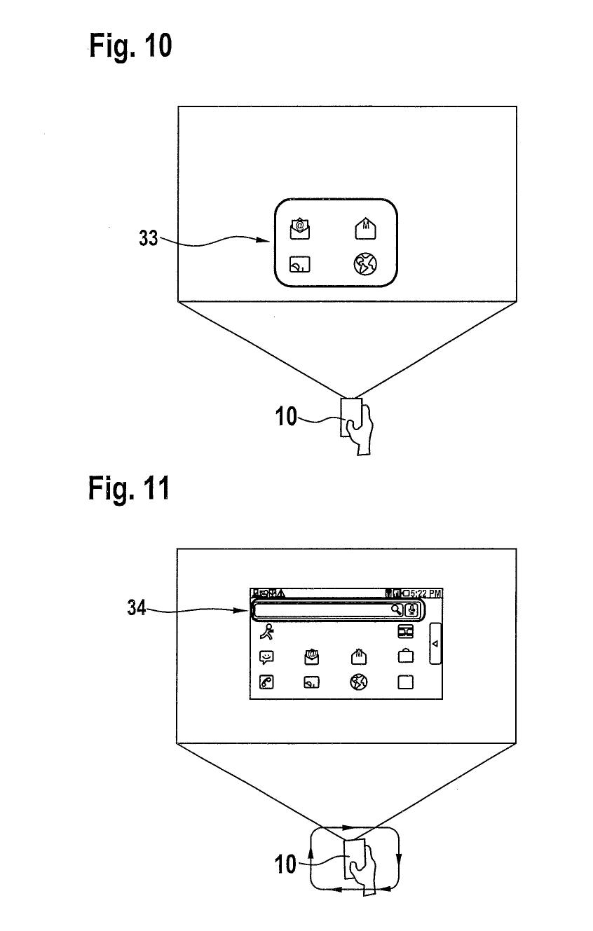

FIG. 4 shows exemplarily the setting of the second operating mode of the present invention. Projected image content 32, in turn, represents the maximally projectable spatial area, respectively angular area of the projection device of electrical device 10. However, the display content, respectively image information 32′ is shown on a reduced scale in FIG. 4. The same holds for FIGS. 5, 6, 7 and 8. In this case, however, a movement of electrical device 10 in accordance with the second operating mode is detected by inertial sensor 12 of electrical device 10, and the display of the image content is compensated in that useful image content 32′ remains substantially fixed on the projection surface, although electrical device 10, and thus also projected image content 32, are moved. This makes it possible to generate a user input in the sense of the movement of pointer information, as is shown exemplarily in FIG. 9 with reference to an area 33 outlined in red. This area is again shown in an enlarged view in FIG. 10. FIG. 9 also reveals that the user moving electrical device 10 in the direction of the arrow sequence shown in the lower portion of the figure suffices to initiate a marking of the screen area outlined in red. In this case, the red outline may correspond to a movement characteristic of pointer projection information 22 that is entrained by the movement of electrical device 10, in each case in spite of the setting of the second operating mode. Another selection area 34 is represented exemplarily in FIG. 11.

What is claimed is:

1. An electrical device, comprising:
a projection device to project image information onto a projection surface disposed externally to the electrical device;
an inertial sensor to detect a movement of the electrical device;
wherein the electrical device is operable in a first operating mode so that the projection of the image information onto the projection surface follows a movement of the electrical device with a movement component in a plane disposed in parallel to the plane of the projection surface,
wherein the electrical device is operable in a second operating mode so that, in spite of the movement of the electrical device, the projection of the image information onto the projection surface with a movement component in a plane disposed in parallel to the plane of the projection surface is at least partially substantially fixed, and
wherein the electrical device is configured so that the movement of the electrical device is interpreted in the second operating mode as a user input.

2. The electrical device of claim 1, wherein the projection of the image information onto the projection surface is increased or reduced in size in the second operating mode relative to the first operating mode.

3. The electrical device of claim 1, wherein in the second operating mode, in response to the movement of the electrical device having a movement component in a plane disposed in parallel to the plane of the projection surface, a portion of the image information disappears on the projection surface, and a portion of the image information appears on the projection surface.

4. The electrical device of claim 1, wherein in the second operating mode, the projection of the image information onto the projection surface is at least partially substantially fixed in spite of the movement of the electrical device, and wherein pointer projection information is followed by the movement of the electrical device with a movement component in a plane disposed in parallel to the plane of the projection surface.

5. The electrical device of claim 1, wherein the electrical device is a telecommunication device, in particular, a stationary or a portable telecommunication terminal, in particular, in the form of a portable computer or a portable cell phone.

6. A method for operating an electrical device, the method comprising:
in a first operating mode of the electrical device, projecting from a projection device a first version of the image information onto the projection surface, wherein the electrical device has an inertial sensor and the projection device to project image information onto the projection surface disposed externally to the electrical device, wherein the electrical device is operable in the first operating mode so that the projection of the image information onto the projection surface follows a movement of the electrical device with a movement component in a plane disposed in parallel to the plane of the projection surface, and wherein the electrical device is operable in a second operating mode so that the projection of the image information onto the projection surface is at least partially substantially fixed in spite of the movement of the electrical device;
in the second operating mode, the electrical device is moved in the plane in parallel to the plane of the projection surface;
detecting a movement of the electrical device by the inertial sensor; and
interpreting the movement of the electrical device in the second operating mode as a user input.

7. The method of claim 6, wherein in the second operating mode, in response to the movement of the electrical device having a movement component in a plane disposed in parallel to the plane of the projection surface, a portion of the image information disappears on the projection surface, and a portion of the image information appears on the projection surface.

8. The method of claim 6, wherein in the second operating mode, the projection of the image information onto the projection surface is at least partially substantially fixed in spite of the movement of the electrical device, and wherein a pointer projection information follows the movement of the electrical device with a movement component in a plane disposed in parallel to the plane of the projection surface.

9. The method of claim 6, wherein the electrical device is a telecommunication terminal.

10. The electrical device of claim 1, wherein the electrical device is a telecommunication device.

11. The electrical device of claim 1, wherein the electrical device is a stationary telecommunication terminal or a portable telecommunication terminal.

12. The electrical device of claim 1, wherein the electrical device is a portable computer or a portable cell phone.
